(19) United States
(12) Patent Application Publication
(10) Pub. No.: US 2011/0177364 A1
(43) Pub. Date: Jul. 21, 2011

(54) NONAQUEOUS ELECTROLYTE SECONDARY BATTERY

(75) Inventors: Shinya Miyazaki, Naruto-shi (JP); Hironori Shirakata, Itano-gun (JP)

(73) Assignee: SANYO ELECTRIC CO., LTD., Osaka (JP)

(21) Appl. No.: 13/010,227

(22) Filed: Jan. 20, 2011

(30) Foreign Application Priority Data
Jan. 21, 2010 (JP) 2010-010821

(51) Int. Cl. H01M 2/12

(52) U.S. Cl. 429/53

(57) ABSTRACT

Provided is a nonaqueous electrolyte secondary battery using lithium-manganese composite oxide as positive electrode active material, having superior high-temperature charge storage characteristics and charge-discharge cycling characteristics and enhanced safety in the event of overcharging. A nonaqueous electrolyte secondary battery according to an aspect of the invention includes: a positive electrode plate provided with a positive electrode mixture containing positive electrode active material, a negative electrode plate, a nonaqueous electrolyte, and a pressure-sensitive safety mechanism that is actuated by rise in internal pressure. The positive electrode active material contains lithium-manganese composite oxide containing 10 to 61% by mass of the element manganese. The positive electrode mixture contains lithium carbonate or calcium carbonate, and lithium phosphate. The nonaqueous electrolyte contains an organic additive made of at least one selected from among biphenyl, a cycloalkyl benzene compound, and a compound having quaternary carbon adjacent to a benzene ring.

### TECHNICAL FIELD

The present invention relates to a nonaqueous electrolyte secondary battery. More particularly, the invention relates to a nonaqueous electrolyte secondary battery that uses lithium-manganese composite oxide as positive electrode active material, has superior high-temperature charge storage characteristics and charge-discharge cycling characteristics, and moreover has enhanced safety in the event of overcharging.

### BACKGROUND ART

The spread of portable equipment in recent years has created demand for sealed batteries, which are compact and lightweight and have high energy density, as power sources for portable equipment. A variety of sealed battery that has come to be much used due to its economicalness is the secondary battery that can be charged and discharged, such as a nickel-hydrogen storage battery or a lithium ion secondary battery. Nonaqueous electrolyte secondary batteries, which are exemplified by the lithium ion secondary battery, have come into particularly wide use due to being more lightweight and having higher energy density than other secondary batteries.

For such a nonaqueous electrolyte secondary battery, LiCoO₂ is generally used for the positive electrode active material, and a carbon material able to absorb and desorb lithium, lithium metal or lithium alloy or lithium is used for the negative electrode active material, while for the nonaqueous electrolyte, use is made of an organic solvent, such as ethylene carbonate or diethyl carbonate, into which an electrolyte constituted of a lithium salt such as LiBF₄ or LiPF₆ is dissolved.

However, the production cost of such batteries is high because the cobalt that is contained in LiCoO₂ is expensive, being a rare resource with limited reserves. Accordingly, the utilization of lithium-nickel composite oxide (such as LiNiO₂), lithium-manganese composite oxide (such as LiMn₂O₄ or LiMnO₂), or the like, instead of LiCoO₂ is being considered. Of these, lithium-manganese composite oxide has the advantageous feature that manganese is a plentiful and low-priced resource, but also has the issues of having low energy density and of lithium-manganese composite oxide itself dissolving at high temperatures.

Nonaqueous electrolyte secondary batteries, no matter whether they use lithium-manganese composite oxide, LiCoO₂, or other substance as the positive electrode active material, are liable to become overcharged if current is supplied for longer than normal during charging, or to become short-circuited if large current flows as a result of misuse or of breakdown of the equipment with which they are used. If such happens, the electrolyte will decompose, producing gas, and the battery internal pressure will rise due to such gas production. Furthermore, if such overcharged or short-circuited state continues, the battery temperature may abruptly rise due to release of heat from rapid decomposition of the positive electrode active material or combustion of the electrolyte, etc., so that the secondary battery, which is a sealed battery, may suddenly explode, damaging the equipment with which it is used. For this reason, batteries equipped with a safety valve for explosion prevention has been used particularly for nonaqueous electrolyte secondary batteries.

In order to prevent explosion of a nonaqueous electrolyte secondary battery due to rise in the battery internal pressure, it is necessary to ensure that the safety valve is actuated correctly when the battery internal pressure rises. However, with a nonaqueous electrolyte secondary battery, it may happen that before the safety valve is actuated, the battery explodes as a result of heat release due to abrupt temperature rise, while the battery internal pressure has not yet risen very much. In order to solve such problem, JP-A-4-328278 discloses an invention of a nonaqueous electrolyte secondary battery whereby lithium carbonate is added to the positive electrode mixture, so that if the positive electrode potential becomes high during overcharge, the lithium carbonate will decompose, producing carbon dioxide gas, whereby the safety valve will be actuated.

It is considered that in such production of carbon dioxide gas due to decomposition of lithium carbonate at the positive electrode, the carbon dioxide gas is produced through the lithium carbonate electrochemically decomposing, and so the carbon dioxide gas in some way or other inhibits abnormal reactions during overcharge, and also that the heat release and relatively rapid damage that would result from abrupt temperature rise are prevented because the carbon gas that is produced reliably actuates the safety valve as can be seen in paragraph [0015] in JP-A-4-328278.

Moreover, JP-A-10-188953 discloses that when an alkali metal carbonate such as lithium carbonate or sodium carbonate is added to a positive electrode mixture containing lithium-manganese composite oxide as the positive electrode material in a nonaqueous electrolyte secondary battery, deterioration of the battery characteristics during repeated charge-discharge cycling in high-temperature states exceeding room temperature can be inhibited. JP-A-2000-11996 also discloses that when lithium phosphate is added to a positive electrode mixture containing spinel type lithium-manganese composite oxide in a nonaqueous electrolyte secondary battery, the charge storage characteristics and charge-discharge cycling characteristics at high temperature are improved, because the phosphate ions function as manganese scavengers.

JP-A-10-154532 also discloses that when lithium phosphate is added to the positive electrode mixture in a nonaqueous electrolyte secondary battery, reaction of the nonaqueous electrolyte during overcharge can be inhibited. International Patent Application 2002/059999 discloses that when tert-amylbenzene and biphenyl are added to the nonaqueous electrolyte in a nonaqueous electrolyte secondary battery, the safety, cycling characteristics, battery capacity, storage characteristics, and other battery characteristics during overcharge and at other times can be improved. Furthermore, JP-A-2008-186792 discloses that when lithium carbonate is contained in the positive electrode mixture and cycloalkyl benzene and a compound having quaternary carbon in a benzene ring are added to the nonaqueous electrolyte, a nonaqueous electrolyte secondary battery with superior overcharge safety and high-temperature charge-discharge cycling characteristics is obtained.

However, with the nonaqueous electrolyte secondary batteries set forth in JP-A-4-328278 and JP-A-10-188953, the addition of lithium carbonate or the like to the positive electrode mixture, while enabling safety during overcharge to be ensured, makes it difficult to ensure the high-temperature charge-discharge cycling characteristics and high-temperature charge storage characteristics. Although JP-A-2000-11996 suggests that the overcharge characteristics are improved by adding lithium phosphate, instead of lithium carbonate, to the positive electrode mixture of a nonaqueous electrolyte secondary battery, almost no improvement will occur in the overcharge characteristics in the case where a positive electrode plate with lithium-manganese composite oxide as the main component of the positive electrode active material is used.

On the other hand, with the nonaqueous electrolyte secondary battery set forth in International Patent Application 2002/059999, although the addition of an organic additive to the nonaqueous electrolyte makes it roughly possible to ensure safety during overcharge, the organic additive must be added in a large amount to the nonaqueous electrolyte in order to ensure adequate safety during overcharge. However, adverse effects such as rise in internal resistance due to side reaction products will occur when the organic additive is added to the nonaqueous electrolyte in an amount sufficient to ensure adequate safety during overcharge, and consequently it is difficult to ensure adequate safety along with good performance solely through addition of an organic additive to the nonaqueous electrolyte.

It has long been known that organic additive contributes to enhancement of the cycling characteristics, charge storage characteristics and so forth of a nonaqueous electrolyte secondary battery, and adding a small amount of organic additive to the nonaqueous electrolyte is an essential configurational requirement. For that reason, when account is also taken of the disclosure in JP-A-2008-186792, it is desirable, in a nonaqueous electrolyte secondary battery that uses lithium-manganese composite oxide as the positive electrode active material, to add a small amount of organic additive to the nonaqueous electrolyte, and to add lithium carbonate or other carbonate to the positive electrode mixture, in order to assure safety during overcharge and to enhance the high-temperature charge storage characteristics and charge-discharge cycling characteristics.

However, the addition of organic additive to the nonaqueous electrolyte makes use of its advantageous effect of inhibiting production of gas, due to inhibiting decomposition of the nonaqueous electrolyte, during overcharge or similar state. By contrast, the addition of lithium carbonate or other carbonate to the positive electrode mixture actively promotes decomposition of the lithium carbonate during overcharge or similar state, thereby causing carbonate gas to be produced and correctly actuating the safety device.

Particularly in a nonaqueous electrolyte secondary battery that uses lithium-manganese composite oxide as the positive electrode active material, the potential rise during overcharge is faster than in the case where lithium-cobalt composite oxide is used as the positive electrode active material. Therefore, if organic additive is added to the nonaqueous electrolyte and lithium carbonate or other carbonate is added to the positive electrode mixture in a nonaqueous electrolyte secondary battery that uses lithium-manganese composite oxide as the positive electrode active material, the reactions of the two will be concerted, so that the advantageous effects of adding the carbonate will not be fully exerted.

More precisely, the decomposition reaction of the carbonate in the positive electrode mixture and the decomposition reaction of the nonaqueous electrolyte, which is accompanied by heat release, occur rapidly and in parallel during overcharge, which means that in order to ensure safety, the addition of the organic additive to the nonaqueous electrolyte and of the carbonate to the positive electrode mixture must be in large amounts. However, as mentioned above, addition of the various additives in large amounts causes decline in the various battery characteristics.

Addition of a large amount of carbonate to the positive electrode mixture, although effective for ensuring safety with regard to rise in battery internal pressure, results in the battery capacity falling, and besides that, renders moisture liable to be brought into the battery system interior due to the high alkalinity of the carbonate, which is liable to have the adverse effect of leading to battery performance decline due to acid or gas produced inside the battery system as a result of reactions with the moisture.

### SUMMARY

An advantage of some aspects of the present invention is to provide a nonaqueous electrolyte secondary battery that, particularly by using lithium-manganese composite oxide as the positive electrode active material, has superior high-temperature charge storage characteristics and charge-discharge cycling characteristics, and moreover is able to achieve enhancement of safety during overcharge.

According to an aspect of the invention, a nonaqueous electrolyte secondary battery includes: a positive electrode plate provided with a positive electrode mixture that contains positive electrode active material able to absorb and desorb lithium ions, a negative electrode plate provided with a negative electrode mixture that contains negative electrode active material able to absorb and desorb lithium ions, a nonaqueous electrolyte, and a pressure-sensitive safety mechanism that is actuated by rise in internal pressure. The positive electrode active material contains lithium-manganese composite oxide that contains 10 to 61% by mass of the element manganese. The positive electrode mixture contains lithium carbonate or calcium carbonate, and lithium phosphate. The nonaqueous electrolyte contains an organic additive made of at least one selected from among biphenyl, a cycloalkyl benzene compound, and a compound having quaternary carbon adjacent to a benzene ring.

In the nonaqueous electrolyte secondary battery of the present aspect of the invention, the positive electrode active material contains lithium-manganese composite oxide that contains 10 to 61% by mass of the element manganese. In such positive electrode active material, there is contained a mixture of an item selected from among, for example, LiMn₂O₄ (manganese content=61% by mass), LiNi_{1/3}CO_{1/3}Mn_{1/3}O₂ (manganese content=19% by mass), LiNi_{0.5}Co_{0.2}Mn_{0.3}O₂ (manganese content=17% by mass), LiNi_{0.5}Co_{0.3}Mn_{0.2}O₂ (manganese content=11% by mass), or LiMn₂O₄, and some other lithium-manganese composite oxide. Note that besides manganese, other metallic elements, such as the above-mentioned Ni and Co, and other transition metal sources, may be contained in the lithium-manganese composite oxides.

The nonaqueous electrolyte secondary battery of the present aspect of the invention is equipped with a pressure-sensitive safety mechanism that is actuated by rise in battery internal pressure, and moreover the positive electrode mixture contains lithium carbonate or calcium carbonate, and lithium phosphate. Furthermore, the nonaqueous electrolyte contains an organic additive made of at least one selected from among biphenyl, a cycloalkyl benzene compound, and a compound having quaternary carbon adjacent to a benzene ring.

As will be described in detail below based on the various examples and comparative examples, with the nonaqueous electrolyte secondary battery of the present aspect of the invention, even though organic additive is present in the nonaqueous electrolyte, the presence of lithium phosphate in the positive electrode mixture means that when an abnormal state such as overcharge occurs, the lithium carbonate or calcium carbonate in the positive electrode mixture will rapidly decompose, producing carbon dioxide gas, and this carbon dioxide gas will actuate the pressure-sensitive safety mechanism, so that a nonaqueous electrolyte secondary battery with superior safety is obtained. In addition, the presence of organic additive yields the advantageous effect of improving the high-temperature charge-discharge cycling characteristics and high-temperature charge storage characteristics, and what is more, the lithium-manganese composite oxide used as the positive electrode active material is low-cost, so that a low-cost nonaqueous electrolyte secondary battery is obtained.

Note that in the nonaqueous electrolyte secondary battery of the present aspect of the invention, if the content of the element manganese in the positive electrode active material is under 10% by mass, then even if the other conditions satisfy the above-mentioned conditions, no advantageous effect will be obtained for the high-temperature cycling characteristics, although an adequate advantageous effect for safety during overcharge will be obtained. Since the content of manganese in LiMn₂O₄ is 61% by mass, it is difficult to have lithium-manganese composite oxide with manganese content exceeding 61% in the positive electrode active material.

With the nonaqueous electrolyte secondary battery of the present aspect of the invention, if lithium phosphate is added to the positive electrode mixture but lithium carbonate or calcium carbonate is not added, or if lithium carbonate or calcium carbonate is added to the positive electrode mixture but lithium phosphate is not added, then even if the other conditions satisfy the above-mentioned conditions, safety during overcharge will be inferior, although the high-temperature charge storage characteristics will be fine.

Furthermore, with the nonaqueous electrolyte secondary battery of the present aspect of the invention, if the nonaqueous electrolyte does not contain an organic additive made of at least one selected from among biphenyl, a cycloalkyl benzene compound, and a compound having quaternary carbon adjacent to a benzene ring, then even though the other conditions satisfy the above-mentioned conditions, the high-temperature charge storage characteristics and high-temperature charge-discharge cycling characteristics will be inferior, although safety during overcharge will be fine.

Examples of the nonaqueous solvents that can be used in the nonaqueous electrolyte of the nonaqueous electrolyte secondary battery of the present aspect of the invention may include cyclic ester carbonates, chain ester carbonates, esters, cyclic ethers, chain ethers, nitriles, and amides.

Examples of the cyclic ester carbonates that can be used may include ethylene carbonate, propylene carbonate, and butylene carbonate. It is possible to use wholly or partially fluorinated forms of these hydrogen groups, for example, trifluoropropylene carbonate, fluoroethyl carbonate or the like may be used. Examples of the chain ester carbonate may include dimethyl carbonate, ethylmethyl carbonate, diethyl carbonate, methylpropyl carbonate, ethylpropyl carbonate, and methylisopropyl carbonate, and it is possible to use wholly or partially fluorinated forms of these hydrogen groups.

Examples of the esters that can be used may include methyl acetate, ethyl acetate, propyl acetate, methyl propionate, ethyl propionate, and γ-butyrolactone. Examples of the cyclic ethers that can be used may include 1,3-dioxolane, 4-methyl-1,3-dioxolane, tetrahydrofuran, 2-methyl tetrahydrofuran, propylene oxide, 1,2-butylene oxide, 1,4-dioxane, 1,3,5-trioxane, furan, 2-methylfuran, 1,8-cineole, and crown ether.

Examples of the chain ethers that can be used may include 1,2-dimethoxyethane, diethylether, dipropylether, diisopropylether, dibutylether, dihexylether, ethylvinylether, butylvinylether, methylphenylether, ethylphenylether, butylphenylether, pentylphenylether, methoxytoluene, benzylethylether, diphenylether, dibenzylether, o-dimethoxybenzene, 1,2-diethoxyethane, 1,2-dibutoxyethane, diethylene glycol dimethylether, diethylene glycol diethylether, diethyleneglycol dibutylether, 1,1-dimethoxymethane, 1,1-diethoxyethane, triethyleneglycol dimethylether, and tetraethyleneglycol dimethylether.

Examples of the nitriles that can be used may include acetonitrile, and of the amides that can be used may include dimethylformamide.

For the nonaqueous solvent of the nonaqueous electrolyte secondary battery of the present aspect of the invention, one or more of the foregoing may be selected. Note that with the nonaqueous electrolyte secondary battery of the present aspect of the invention, the nonaqueous electrolyte may be used not only in a liquid state but also in a gelled state.

As the electrolyte salt for the nonaqueous electrolyte in the nonaqueous electrolyte secondary battery of the present aspect of the invention, the electrolyte salts that have long been in general use in nonaqueous electrolyte secondary batteries may be used. For example, one or more selected from among the following may be used: LiBF₄, LiPF₆, LiCF₃SO₃, LiC₄F₉SO₃, LiN(CF₃SO₂)₂, LiN(C₂F₅SO₂)₂, LiAsF₆, difluoro (oxalato) lithium borate. Of these, LiPF₆ will be particularly preferable. The amount of solute dissolved in the aforementioned nonaqueous solvent will preferably be 0.5 to 2.0 mol/L.

Examples of the materials that can be used for the negative electrode active material in the present aspect of the invention may include carbon materials such as lithium metal, lithium alloy and graphite, silicon materials, lithium composite oxides, or other material that is able to absorb and desorb lithium.

As regards the shape of the battery outer can of the nonaqueous electrolyte secondary battery of the present aspect of the invention, an item of prismatic shape, cylindrical shape, coin shape or other shape may be used, provided that it is sealed by a sealing plate that is equipped with a safety valve mechanism.

The positive electrode mixture in the nonaqueous electrolyte secondary battery of the present aspect of the invention preferably contains 0.1% by mass or more and 5.0% by mass or less of the lithium carbonate or calcium carbonate relative to the total mass of the positive electrode active material.

With the nonaqueous electrolyte secondary battery of the present aspect of the invention, if the lithium carbonate or calcium carbonate content in the positive electrode mixture is under 0.1% by mass, then even if the other conditions satisfy the above-mentioned conditions, it will not be possible to ensure safety during overcharge and the advantageous effects of adding the lithium carbonate or calcium carbonate will not be obtained. Furthermore, it will not be desirable for the lithium carbonate or calcium carbonate content in the positive electrode mixture to exceed 5% by mass, because then there will be a corresponding decrease in the per-unit-volume amount of positive electrode active material that is added, manifesting as a fall in battery capacity.

Alternatively, the positive electrode mixture in the nonaqueous electrolyte secondary battery of the present aspect of the invention preferably contains 0.1% by mass or more and 5.0% by mass or less of the lithium phosphate relative to the total mass of the positive electrode active material.

With the nonaqueous electrolyte secondary battery of the present aspect of the invention, if the lithium phosphate content in the positive electrode mixture is under 0.1% by mass, then even if the other conditions satisfy the above-mentioned conditions, it will not be possible to ensure safety during overcharge and the advantageous effects of adding the lithium phosphate will not be obtained. It will not be desirable for the lithium phosphate content in the positive electrode mixture to exceed 5% by mass, because then there will be a corresponding decrease in the per-unit-volume amount of positive electrode active material that is added, manifesting as a fall in battery capacity.

Alternatively, the nonaqueous electrolyte in the nonaqueous electrolyte secondary battery of the present aspect of the invention preferably contains 0.1% by mass or more and 5.0% by mass or less of the organic additive.

With the nonaqueous electrolyte secondary battery of the present aspect of the invention, it will not be desirable for the amount of organic additive, constituted of one or more items selected from among biphenyl, a cycloalkyl benzene compound, and a compound having quaternary carbon adjacent to a benzene ring, that is added to be under 0.1% by mass, because then, even if the other conditions satisfy the above-mentioned conditions, the advantageous effects of adding the organic additive will not manifest. Likewise, it will not be desirable for such amount to exceed 5% by mass, because then the high-temperature charge storage characteristics and charge-discharge cycling characteristics will be inferior.

For the nonaqueous electrolyte in the nonaqueous electrolyte secondary battery of the present aspect of the invention, cyclohexylbenzene may be used as the cycloalkyl benzene compound, and tert-amylbenzene as the compound having quaternary carbon adjacent to a benzene ring. With the nonaqueous electrolyte secondary battery of the present aspect of the invention, the nonaqueous electrolyte may further contain 1.5 to 5% by mass vinylene carbonate.

### DESCRIPTION OF EXEMPLARY EMBODIMENTS

Exemplary embodiments of the invention will now be described in detail with reference to various types of examples and comparative examples. It should be noted that the examples described below are illustrative examples of nonaqueous electrolyte secondary batteries for embodying the technical spirit of the invention and are not intended to limit the invention to these examples, and the invention may be equally applied to various modified cases without departing from the technical spirit described in the claims.

### Examples 1 to 6

Firstly, a specific nonaqueous secondary battery manufacturing method that is common to Examples 1 to 6 will be described.

### Fabrication of Positive Electrode Plate

First, carbonates were coprecipitated by adding sodium hydrogen carbonate to a sulfate water solution containing the components Ni, Co and Mn in appropriate amounts. Then these coprecipitated carbonates were made to undergo thermal decomposition reactions, and whereby the mixture of oxides that would serve as raw material was obtained. Next, using lithium carbonate (Li₂CO₃) as the lithium-source starting ingredient, the mixture of oxides and the lithium carbonate were mixed in a mortar, and by baking the resulting mixture in air, a baked body of lithium-manganese composite oxide (LiMn₂O₄) or of lithium-containing nickel-cobalt-manganese composite oxide with the various components, was obtained.

After that, the baked body thus synthesized was pulverized until its average particle diameter was 10 μm, whereby the positive electrode active material was obtained. The amounts of Ni, Co and Mn contained in the synthesized baked body were determined via ICP (inductively coupled plasma) emission spectroscopy. The positive electrode active materials in the Examples 1 to 6 were as follows: LiMn₂O₄ in the Example 1, LiNi_{1/3}Co_{1/3}Mn_{1/3}O₂ and LiMn₂O₄ in the ratio 6:4 in the Example 2, LiNi_{1/3}Co_{1/3}Mn_{1/3}O₂ and LiMn₂O₄ in the ratio 8:2 in the Example 3, LiNi_{1/3}Co_{1/3}Mn_{1/3}O₂ in the Example 4, LiNi_{0.5}CO_{0.2}Mn_{0.3}O₂ in the Example 5, and LiNi_{0.5}CO_{0.3}Mn_{0.3}O₂ in the Example 6. The mix ratios in Examples 2 and 3 were mass ratios (the same applies in the examples and comparative examples below).

A mixture was then prepared that was constituted of 92% by mass of the positive electrode active material thus fabricated, 1% by mass of lithium carbonate, 1% by mass of lithium phosphate, 3% by mass of carbon powder serving as conducting agent, and 3% by mass of polyvinylidene fluoride (PVdF) serving as binding agent. N-methylpyrolidone (NMP) was then added to the prepared mixture to obtain positive electrode mixture in slurry form. Such slurry-form positive electrode mixture was then applied, using the doctor blade method, to both sides of a 20 μm thick aluminum foil, which was heated and dried, rolled with a compacting roller, and cut out into a particular size to obtain a positive electrode plate.

Fabrication of Negative Electrode Plate

A negative electrode mixture in slurry form was obtained by mixing negative electrode active material constituted of graphite, carboxymethylcellulose (CMC) serving as thickener, and styrenebutadiene rubber (SBR) serving as binding agent, in the proportions 97%, 2% and 1% by mass respectively, and adding water thereto. Such slurry-form negative electrode mixture was then applied, using the doctor blade method, to both sides of a 12-μm thick copper foil, which was heated and dried, rolled with a compacting roller, and cut out into a particular size to obtain a negative electrode plate.

Note that the potential of the graphite was 0.1V with reference to the Li. The amounts of active material packed in the positive electrode plate and the negative electrode plate were adjusted so that the positive electrode and negative electrode charging capacity ratio (negative electrode charging capacity/positive electrode charging capacity) at the positive electrode active material potential that serves as the design standard was 1.1.

Preparation of Nonaqueous Electrolyte

The nonaqueous electrolyte was prepared by dissolving LiPF₆ in a mixed solution of ethylene carbonate (EC), dimethyl carbonate (DMC), methylethyl carbonate (MEC), vinylene carbonate (VC), and tert-amylbenzene. The proportions by mass of the various components of the nonaqueous electrolyte thus obtained, relative to the total mass of such electrolyte, were: EC 25%, DMC 52%, MEC 8%, VC 2%, tert-amylbenzene 1%, and LiPFs 12%.

Fabrication of Battery

Using the positive electrode plate, negative electrode plate and nonaqueous electrolyte that were produced as described above, a cylindrical nonaqueous electrolyte secondary battery (capacity 1500 mAh, height 65 mm, diameter 18 mm) pertaining to the Examples 1 to 6 was fabricated. Note that a microporous membrane of polypropylene was used for the separators.

### Comparative Examples 1 to 18

The batteries in Comparative Examples 1 to 18 were the nonaqueous electrolyte secondary battery for the Examples 1 to 6, without tert-amylbenzene added to the nonaqueous electrolyte in the case of the Comparative Examples 1 to 6, without lithium phosphate added to the positive electrode mixture in the case of the Comparative Examples 7 to 12, and without lithium carbonate added to the positive electrode mixture in the case of the Comparative Examples 13 to 18. In each of these Comparative Examples 1 to 6, 7 to 12, and 13 to 18, the positive electrode active material varied according to the same sequence as for the Examples 1 to 6.

### Comparative Examples 19 and 20

The batteries for Comparative Examples 19 and 20 were prepared in the same way as the batteries for the Examples 1 to 6, except that LiNi_{0.5}Co_{0.4}Mn_{0.1}O₂ (for the Comparative Example 19) or LiCoO₂ (for the Comparative Example 20) was used as the positive electrode active material.

### Examples 7 and 8

The batteries for Examples 7 and 8 were prepared in the same way as the battery for the Example 3, using LiNi_{1/3}Co_{1/3}Mn_{1/3}O₂ and LiMn₂O₄ in the ratio 8:2 as the positive electrode active material, except that the content of such positive electrode active material in the positive electrode mixture was 0.1% by mass in the Example 7 and 5.0% by mass in the Example 8.

### Examples 9 and 10

The batteries for the Examples 9 and 10 were prepared in the same way as the battery for the Example 3, using LiNi_{1/3}Co_{1/3}Mn_{1/3}O₂ and LiMn₂O₄ in the ratio 8:2 as the positive electrode active material, and with the amounts of such positive electrode active material and of lithium carbonate contained in the positive electrode mixture being the same as in the Example 3, except that the content of lithium phosphate in the positive electrode mixture was 0.1% by mass in the Example 9 and 5.0% by mass in the Example 10.

### Examples 11 and 12, and Comparative Example 21

The batteries for Examples 11 and 12, and Comparative Example 21 were prepared in the same way as the battery for the Example 3, using LiNi_{1/3}Co_{1/3}Mn_{1/3}O₂ and LiMn₂O₄ in the ratio 8:2 as the positive electrode active material, and with the amounts of such positive electrode active material, of lithium carbonate, and of lithium phosphate contained in the positive electrode mixture being the same as in the Example 3, except that the content of tert-amylbenzene in the nonaqueous electrolyte was 0.1% by mass in the Example 11, 5.0% by mass in the Example 12, and 7.0% by mass in the Comparative Example 21.

Overcharge Testing

Overcharge tests were conducted as follows. Each battery was charged with constant current of 1 It=1500 mA at 25° C., then, after the battery voltage had reached 4.2V, was charged with constant voltage of 4.2V until the charging current became (1/50) It=30 mA, which was taken to be the full-charged state. After that, overcharging was continued with a constant current level of 1300 mA, and the battery was deemed to be abnormal (“NG”) if smoke emission or ignition resulted. Batteries that did not emit smoke or ignite during the overcharge test were deemed to be normal (“OK”).

High-Temperature Charge Storage Characteristic

The high-temperature charge storage characteristic was determined as follows. Each battery was charged with constant current of 1 It=1500 mA at 25° C., then, after the battery voltage had reached 4.2V, was charged with constant voltage of 4.2V until the charging current became (1/50) It=30 mA, which was taken to be the full-charged state. After that, discharge was implemented at constant current of 1 It=1500 mA down to battery voltage of 2.75 V, and the amount of charge that flowed during such discharge was measured and taken to be the pre-storage capacity.

Following that, once again each battery was charged with constant current of 1 It=1500 mA at 25° C., then, after the battery voltage had reached 4.2 V, was charged with constant voltage of 4.2 V until the charging current became (1/50) It=30 mA, which was taken to be the full-charged state. Then each battery was stored for 300 hours in a thermostatic chamber maintained at 70° C. Following that, each battery was cooled down to 25° C., and discharge was implemented at 25° C. at constant current of 1 It=1500 mA down to battery voltage of 2.75 V. The amount of charge that flowed during such discharge was measured and taken to be the post-storage capacity. The high-temperature charge storage characteristic value (%) was then derived by means of the following calculation formula:

High-temperature charge storage characteristic value (%)=(Post-storage capacity/Pre-storage capacity)×100

High-temperature charge-discharge cycling characteristic

The high-temperature charge-discharge cycling characteristic was determined as follows. Inside a thermostatic chamber maintained at 70° C., each battery was charged with constant current of 1 It=1500 mA, then, after the battery voltage had reached 4.2 V, each battery was charged with constant voltage of 4.2 V until the charging current became (1/50) It=30 mA, which was taken to be the full-charged state. After that, discharge was implemented at constant current of 1 It=1500 mA down to battery voltage of 2.75 V, and the amount of charge that flowed during such discharge was measured and taken to be the discharged capacity of the first cycle. Next, 350 such charge-discharge cycles were conducted in succession, and the high-temperature charge-discharge cycling characteristic value (%) was derived by means of the following calculation formula:

High-temperature charge-discharge cycling characteristic value (%)=(Discharged capacity of 350th cycle/Discharged capacity of 1st cycle)×100

The measurement results obtained as described above are gathered in Table 1 concerning the Examples 1 to 6, and Comparative Examples 1 to 18, in Table 2 concerning the Examples 1 to 6 and Comparative Examples 19 and 20, in Table 3 concerning the Comparative Example 15 and the Examples 3, 7 and 8, in Table 4 concerning the Comparative Example 9 and the Examples 3, 9 and 10, and in Table 5 concerning the Comparative Examples 3 and 21, and the Examples 3, 11 and 12.

TABLE 1

| | | Mn | Lithium | Lithium | | High- | |
|---|---|---|---|---|---|---|---|
| | | concentration | carbonate | phosphate | Amylbenzene | temperature | Over- |
| | Positive electrode | (% by mass) | (% by mass) | (% by mass) | (% by mass) | storage (%) | charge |
| Example 1 | LiMn₂O₄ | 61 | 1.0 | 1.0 | 1.0 | 85 | OK |
| Example 2 | LiNi_{1/3}Co_{1/3}Mn_{1/3}O₂: | 36 | 1.0 | 1.0 | 1.0 | 90 | OK |
| | LiMn₂O₄ = 6:4 | | | | | | |
| Example 3 | LiNi_{1/3}Co_{1/3}Mn_{1/3}O₂: | 27 | 1.0 | 1.0 | 1.0 | 93 | OK |
| | LiMn₂O₄ = 8:2 | | | | | | |
| Example 4 | LiNi_{1/3}Co_{1/3}Mn_{1/3}O₂ | 19 | 1.0 | 1.0 | 1.0 | 94 | OK |
| Example 5 | LiNi_{0.5}Co_{0.2}Mn_{0.3}O₂ | 17 | 1.0 | 1.0 | 1.0 | 92 | OK |
| Example 6 | LiNi_{0.5}Co_{0.3}Mn_{0.2}O₂ | 11 | 1.0 | 1.0 | 1.0 | 93 | OK |
| Comparative Example 1 | LiMn₂O₄ | 61 | 1.0 | 1.0 | 0 | 79 | OK |
| Comparative Example 2 | LiNi_{1/3}Co_{1/3}Mn_{1/3}O₂: | 36 | 1.0 | 1.0 | 0 | 83 | OK |
| | LiMn₂O₄ = 6:4 | | | | | | |
| Comparative Example 3 | LiNi_{1/3}Co_{1/3}Mn_{1/3}O₂: | 27 | 1.0 | 1.0 | 0 | 83 | OK |
| | LiMn₂O₄ = 8:2 | | | | | | |
| Comparative Example 4 | LiNi_{1/3}Co_{1/3}Mn_{1/3}O₂ | 19 | 1.0 | 1.0 | 0 | 83 | OK |
| Comparative Example 5 | LiNi_{0.5}Co_{0.2}Mn_{0.3}O₂ | 17 | 1.0 | 1.0 | 0 | 84 | OK |
| Comparative Example 6 | LiNi_{0.5}Co_{0.3}Mn_{0.2}O₂ | 11 | 1.0 | 1.0 | 0 | 84 | OK |
| Comparative Example 7 | LiMn₂O₄ | 61 | 1.0 | 0 | 1.0 | 81 | NG |
| Comparative Example 8 | LiNi_{1/3}Co_{1/3}Mn_{1/3}O₂: | 36 | 1.0 | 0 | 1.0 | 88 | NG |
| | LiMn₂O₄ = 6:4 | | | | | | |
| Comparative Example 9 | LiNi_{1/3}Co_{1/3}Mn_{1/3}O₂: | 27 | 1.0 | 0 | 1.0 | 91 | NG |
| | LiMn₂O₄ = 8:2 | | | | | | |
| Comparative Example 10 | LiNi_{1/3}Co_{1/3}Mn_{1/3}O₂ | 19 | 1.0 | 0 | 1.0 | 91 | NG |
| Comparative Example 11 | LiNi_{0.5}Co_{0.2}Mn_{0.3}O₂ | 17 | 1.0 | 0 | 1.0 | 90 | NG |
| Comparative Example 12 | LiNi_{0.5}Co_{0.3}Mn_{0.2}O₂ | 11 | 1.0 | 0 | 1.0 | 90 | NG |
| Comparative Example 13 | LiMn₂O₄ | 61 | 0 | 1.0 | 1.0 | 82 | NG |
| Comparative Example 14 | LiNi_{1/3}Co_{1/3}Mn_{1/3}O₂: | 36 | 0 | 1.0 | 1.0 | 89 | NG |
| | LiMn₂O₄ = 6:4 | | | | | | |
| Comparative Example 15 | LiNi_{1/3}Co_{1/3}Mn_{1/3}O₂: | 27 | 0 | 1.0 | 1.0 | 92 | NG |
| | LiMn₂O₄ = 8:2 | | | | | | |
| Comparative Example 16 | LiNi_{1/3}Co_{1/3}Mn_{1/3}O₂ | 19 | 0 | 1.0 | 1.0 | 92 | NG |
| Comparative Example 17 | LiNi_{0.5}Co_{0.2}Mn_{0.3}O₂ | 17 | 0 | 1.0 | 1.0 | 91 | NG |
| Comparative Example 18 | LiNi_{0.5}Co_{0.3}Mn_{0.2}O₂ | 11 | 0 | 1.0 | 1.0 | 91 | NG |

The measurement results gathered in Table 1 are for batteries with Mn concentration ranging from 11 to 61% by mass and with lithium carbonate and lithium phosphate contained in the positive electrode mixture, with the results for the Examples 1 to 6 being for a battery with tert-amylbenzene contained in an organic electrolyte, the results for the Comparative Examples 1 to 6 being for a battery without tert-amylbenzene contained in the electrolyte, the results for the Comparative Examples 7 to 12 being for a battery without lithium phosphate contained in the positive electrode mixture, and the results for the Comparative Examples 13 to 18 being for a battery without lithium carbonate contained in the positive electrode mixture.

From the measurement results set forth in Table 1, it will be seen that with Mn concentration within the range 11 to 61% by mass, the batteries that have lithium carbonate and lithium phosphate contained in the positive electrode mixture and tert-amylbenzene contained in an organic electrolyte (Examples 1 to 6) all have a high-temperature charge storage characteristic of 85% or higher and also have a fine overcharge characteristic, thus exhibiting excellent results.

However, even with Mn concentration within the range 11 to 61% by mass, the batteries that do not have tert-amylbenzene contained in the electrolyte (Comparative Examples 1 to 6) have a high-temperature charge storage characteristic slightly lower than the Examples 1 to 6, although their overcharge characteristic is fine. Similarly, the batteries that do not have lithium phosphate contained in the positive electrode mixture (Comparative Examples 7 to 12) all have an inferior overcharge characteristic, with the exception of the LiMn₂O₄ case (Comparative Example 7), although their high-temperature charge storage characteristic is fine. Likewise, the batteries that do not have lithium carbonate contained in the positive electrode mixture (Comparative Examples 13 to 18) all have an inferior overcharge characteristic, with the exception of the LiMn₂O₄ case (Comparative Example 13), although their high-temperature charge storage characteristic is fine.

From the foregoing it will be understood that provided, at the least, that the concentration of manganese in the positive electrode active material is within the range 11 to 61% by mass, then with batteries that have lithium carbonate and lithium phosphate contained in the positive electrode mixture and tert-amylbenzene contained in the organic electrolyte, good results are obtained for both the high-temperature charge storage characteristic and the overcharge characteristic.

TABLE 2

| | | Mn | Lithium | Lithium | | High- | |
|---|---|---|---|---|---|---|---|
| | | concentration | carbonate | phosphate | Amylbenzene | temperature | Over- |
| | Positive electrode | (% by mass) | (% by mass) | (% by mass) | (% by mass) | cycle (%) | charge |
| Example 1 | LiMn₂O₄ | 61 | 1.0 | 1.0 | 1.0 | 72 | OK |
| Example 2 | LiNi_{1/3}Co_{1/3}Mn_{1/3}O₂: | 36 | 1.0 | 1.0 | 1.0 | 75 | OK |
| | LiMn₂O₄ = 6:4 | | | | | | |
| Example 3 | LiNi_{1/3}Co_{1/3}Mn_{1/3}O₂: | 27 | 1.0 | 1.0 | 1.0 | 73 | OK |
| | LiMn₂O₄ = 8:2 | | | | | | |
| Example 4 | LiNi_{1/3}Co_{1/3}Mn_{1/3}O₂ | 19 | 1.0 | 1.0 | 1.0 | 75 | OK |
| Example 5 | LiNi_{0.5}Co_{0.2}Mn_{0.3}O₂ | 17 | 1.0 | 1.0 | 1.0 | 74 | OK |
| Example 6 | LiNi_{0.5}Co_{0.3}Mn_{0.2}O₂ | 11 | 1.0 | 1.0 | 1.0 | 74 | OK |
| Comparative Example 19 | LiNi_{0.5}Co_{0.4}Mn_{0.1}O₂ | 6 | 1.0 | 1.0 | 1.0 | 69 | OK |
| Comparative Example 20 | LiCoO₂ | 0 | 1.0 | 1.0 | 1.0 | 71 | OK |

Table 2 gathers the measurement results for the high-temperature charge-discharge cycling characteristic and the overcharge characteristic with various concentrations of manganese in the positive electrode active material, when lithium carbonate and lithium phosphate are contained in the positive electrode mixture and tert-amylbenzene is contained in the organic electrolyte. From the results set forth in Table 2, it will be seen that with batteries that have lithium carbonate and lithium phosphate contained in the positive electrode mixture and tert-amylbenzene contained in the organic electrolyte, fine results are obtained for the overcharge characteristic regardless of the manganese concentration. The high-temperature charge-discharge cycling characteristic is fine in the Examples 1 to 6, in which the manganese concentration is 11% or higher, but in the Comparative Example 19, in which the manganese concentration is under 11, the high-temperature charge-discharge cycling characteristic is inferior to the Examples 1 to 6.

Note that the battery of the Comparative Example 20, in which the concentration of manganese in the positive electrode active material is 0% by mass, is not pertinent to the invention. Moreover, it is difficult to obtain a lithium-manganese composite oxide with manganese concentration of 61% or higher. Therefore, it will be understood that in cases where the positive electrode mixture contains lithium carbonate and lithium phosphate and the organic electrolyte contains tert-amylbenzene, superior results for both the high storage characteristic (see Table 1), the high-temperature charge-discharge characteristic and the overcharge characteristic will be obtained, provided that the battery has manganese concentration of 10 to 61% by mass when inserted in the positive electrode active material.

TABLE 3

| | | Lithium carbonate | Lithium phosphate | Amylbenzene | High-temperature | Over- |
|---|---|---|---|---|---|---|
| | Positive electrode | (% by mass) | (% by mass) | (% by mass) | storage (%) | charge |
| Comparative Example 15 | LiNi_{1/3}Co_{1/3}Mn_{1/3}O₂: | 0 | 1.0 | 1.0 | 92 | NG |
| | LiMn₂O₄ = 8:2 | | | | | |
| Example 7 | LiNi_{1/3}Co_{1/3}Mn_{1/3}O₂: | 0.1 | 1.0 | 1.0 | 93 | OK |
| | LiMn₂O₄ = 8:2 | | | | | |
| Example 3 | LiNi_{1/3}Co_{1/3}Mn_{1/3}O₂: | 1.0 | 1.0 | 1.0 | 93 | OK |
| | LiMn₂O₄ = 8:2 | | | | | |
| Example 8 | LiNi_{1/3}Co_{1/3}Mn_{1/3}O₂: | 5.0 | 1.0 | 1.0 | 93 | OK |
| | LiMn₂O₄ = 8:2 | | | | | |

Table 3 sets forth the measurement results for the high-temperature charge storage characteristic and the overcharge characteristic with various amounts of lithium carbonate contained in the positive electrode mixture, when the positive electrode active material is constituted of LiNi_{1/3}Co_{1/3}Mn_{1/3}O₂ and LiMn₂O₄ in the ratio 8:2 (manganese concentration=27% by mass), lithium phosphate is contained in the positive electrode mixture, and tert-amylbenzene is contained in the organic electrolyte. From the results set forth in Table 3, it will be seen that the high-temperature charge storage characteristic is fine regardless of whether or not lithium carbonate is contained in the positive electrode mixture, but that the overcharge characteristic is inferior with the battery that does not have lithium carbonate contained in the positive electrode mixture (Comparative Example 15).

From the fact that with the batteries that have lithium carbonate content ranging from 0.1 to 5.0% by mass in the positive electrode mixture (Examples 7, 3 and 8), no substantial difference arises in the high-temperature charge storage characteristic, it will be understood that the advantageous effect of adding lithium carbonate to the positive electrode mixture occurs with a content of 0.1% by mass or more. However, since the lithium carbonate does not contribute to the electrode reactions, adding it in a proportion exceeding 5.0% by mass will necessitate a corresponding reduction in the amount of positive electrode active material that is added, because the volume of the battery outer can interior is limited. Therefore, the amount of lithium carbonate that is added to the positive electrode mixture should be no more than 5% by mass.

TABLE 4

| | | | | | High- | |
|---|---|---|---|---|---|---|
| | | Lithium | Lithium | | temperature | |
| | | carbonate | phosphate | Amylbenzene | storage | Over- |
| | Positive electrode | (% by mass) | (% by mass) | (% by mass) | (%) | charge |
| Comparative Example 9 | LiNi_{1/3}Co_{1/3}Mn_{1/3}O₂: | 1.0 | 0 | 1.0 | 91 | NG |
| | LiMn₂O₄ = 8:2 | | | | | |
| Example 9 | LiNi_{1/3}Co_{1/3}Mn_{1/3}O₂: | 1.0 | 0.1 | 1.0 | 93 | OK |
| | LiMn₂O₄ = 8:2 | | | | | |
| Example 3 | LiNi_{1/3}Co_{1/3}Mn_{1/3}O₂: | 1.0 | 1.0 | 1.0 | 93 | OK |
| | LiMn₂O₄ = 8:2 | | | | | |
| Example 10 | LiNi_{1/3}Co_{1/3}Mn_{1/3}O₂: | 1.0 | 5.0 | 1.0 | 93 | OK |
| | LiMn₂O₄ = 8:2 | | | | | |

Table 4 sets forth the measurement results for the high-temperature charge storage characteristic and the overcharge characteristic with various amounts of lithium phosphate contained in the positive electrode mixture, when the positive electrode active material is constituted of LiNi_{1/3}Co_{1/3}Mn_{1/3}O₂ and LiMn₂O₄ in the ratio 8:2 (manganese concentration=27% by mass), lithium carbonate is contained in the positive electrode mixture, and tert-amylbenzene is contained in the organic electrolyte. From the results set forth in Table 4, it will be seen that the high-temperature charge storage characteristic is fine regardless of whether or not lithium phosphate is contained in the positive electrode mixture, but that the overcharge characteristic is inferior with the battery that does not have lithium phosphate contained in the positive electrode mixture (Comparative Example 9).

From the fact that with the batteries that have lithium phosphate content ranging from 0.1 to 5.0% by mass in the positive electrode mixture (Examples 9, 3 and 10), no substantial difference arises in the high-temperature charge storage characteristic, it will be understood that the advantageous effect of adding lithium phosphate to the positive electrode mixture occurs with a content of 0.1% by mass or more. However, since the lithium phosphate does not contribute to the electrode reactions, adding it in a proportion exceeding 5.0% by mass will necessitate a corresponding reduction in the amount of positive electrode active material that is added, because the volume of the battery outer can interior is limited. Therefore, the amount of lithium phosphate that is added to the positive electrode mixture should be no more than 5% by mass.

TABLE 5

| | | Lithium | Lithium | | High- | High- | |
|---|---|---|---|---|---|---|---|
| | | carbonate | phosphate | Amylbenzene | temperature | temperature | Over- |
| | Positive electrode | (% by mass) | (% by mass) | (% by mass) | cycle (%) | storage (%) | charge |
| Comparative Example 3 | LiNi_{1/3}Co_{1/3}Mn_{1/3}O₂: | 1.0 | 1.0 | 0 | 71 | 83 | OK |
| | LiMn₂O₄ = 8:2 | | | | | | |
| Example 11 | LiNi_{1/3}Co_{1/3}Mn_{1/3}O₂: | 1.0 | 1.0 | 0.1 | 73 | 92 | OK |
| | LiMn₂O₄ = 8:2 | | | | | | |
| Example 3 | LiNi_{1/3}Co_{1/3}Mn_{1/3}O₂: | 1.0 | 1.0 | 1.0 | 73 | 93 | OK |
| | LiMn₂O₄ = 8:2 | | | | | | |
| Example 12 | LiNi_{1/3}Co_{1/3}Mn_{1/3}O₂: | 1.0 | 1.0 | 5.0 | 72 | 93 | OK |
| | LiMn₂O₄ = 8:2 | | | | | | |
| Comparative Example 21 | LiNi_{1/3}Co_{1/3}Mn_{1/3}O₂: | 1.0 | 1.0 | 7.0 | 68 | 84 | OK |
| | LiMn₂O₄ = 8:2 | | | | | | |

Table 5 sets forth the measurement results for the high-temperature charge-discharge cycling characteristic, the high-temperature charge storage characteristic and the overcharge characteristic with various amounts of tert-amylbenzene contained in the organic electrolyte, when the positive electrode active material is constituted of LiNi_{1/3}Co_{1/3}Mn_{1/3}O₂ and LiMn₂O₄ in the ratio 8:2 (manganese concentration=27% by mass), and lithium carbonate and lithium phosphate are contained in the positive electrode mixture. From the results set forth in Table 5, it will be seen that the overcharge characteristic is fine regardless of whether or not tert-amylbenzene is contained in the organic electrolyte, but that the high-temperature charge storage characteristic is inferior with the battery that does not have tert-amylbenzene contained in the organic electrolyte (Comparative Example 3) and the battery that has tert-amylbenzene content of 7% by mass in the organic electrolyte (Comparative Example 21). Note that with the battery that has tert-amylbenzene content of 7% by mass in the organic electrolyte (Comparative Example 21), the high-temperature charge-discharge cycling characteristic also is inferior to the Examples 11, 3 and 12.

More precisely, from the fact that with the batteries that have tert-amylbenzene content ranging from 0.1 to 5.0% by mass in the organic electrolyte (Examples 11, 3 and 12), no substantial difference arises in the high-temperature charge-discharge cycling characteristic and high-temperature charge storage characteristic, it will be understood that the advantageous effect of adding tert-amylbenzene to the organic electrolyte occurs with a content of 0.1% by mass or more. However, with the battery that has tert-amylbenzene content of 7% by mass in the organic electrolyte (Comparative Example 21), the high-temperature charge storage characteristic is on the same level as that of the battery that does not have tert-amylbenzene contained in the organic electrolyte (Comparative Example 3). Furthermore, the high-temperature charge-discharge cycling characteristic is inferior to that of the battery that does not have tert-amylbenzene contained in the organic electrolyte. Hence, the amount of tert-amylbenzene that is added to the organic electrolyte should be no more than 5% by mass.

Summarizing the foregoing measurement results, it is obvious that if a nonaqueous electrolyte secondary battery is equipped with a pressure-sensitive safety mechanism that is actuated by rise in the battery internal pressure, and if lithium-manganese composite oxide containing 10 to 61% by mass of the element manganese is used as the positive electrode active material, lithium carbonate and lithium phosphate are contained in the positive electrode mixture, and tert-amylbenzene is contained in the nonaqueous electrolyte, then a nonaqueous electrolyte secondary battery will be obtained that has fine high-temperature charge-discharge cycling characteristics and high-temperature charge storage characteristics, and moreover also has fine overcharge characteristics.

In such case, if the amounts of lithium carbonate and lithium phosphate added to the positive electrode mixture are both within the range 0.1 to 5% by mass, and the amount of tert-amylbenzene contained in the nonaqueous electrolyte is within the range 0.1 to 5% by mass, then a nonaqueous electrolyte secondary battery will be obtained in which, without any fall occurring in the battery capacity, the high-temperature charge-discharge cycling characteristics, high-temperature charge storage characteristics and overcharge characteristics are fine.

In addition, since the lithium-manganese composite oxide used as the positive electrode active material is low-cost, a low-cost nonaqueous electrolyte secondary battery will be obtained.

Note that although the foregoing embodiments illustrate only cases where lithium carbonate is added to the positive electrode mixture, using calcium carbonate instead of lithium carbonate will yield the same advantageous effects. Likewise, although only examples where tert-amylbenzene is the organic additive added to the organic electrolyte have been described, the same advantageous effects will be exerted if one or more items selected from among biphenyl, a cycloalkyl benzene compound, and a compound having quaternary carbon adjacent to a benzene ring, are used.

What is claimed is:

1. A nonaqueous electrolyte secondary battery comprising:
a positive electrode plate provided with a positive electrode mixture that contains positive electrode active material able to absorb and desorb lithium ions;
a negative electrode plate provided with a negative electrode mixture that contains negative electrode active material able to absorb and desorb lithium ions;
a nonaqueous electrolyte; and
a pressure-sensitive safety mechanism that is actuated by rise in internal pressure;
the positive electrode active material containing lithium-manganese composite oxide that contains 10 to 61% by mass of the element manganese,
the positive electrode mixture containing lithium carbonate or calcium carbonate, and lithium phosphate, and
the nonaqueous electrolyte containing an organic additive made of at least one selected from among biphenyl, a cycloalkyl benzene compound, and a compound having quaternary carbon adjacent to a benzene ring.

2. The nonaqueous electrolyte secondary battery according to claim 1, wherein the positive electrode mixture contains 0.1% by mass or more and 5.0% by mass or less of the lithium carbonate or calcium carbonate relative to the total mass of the positive electrode active material.

3. The nonaqueous electrolyte secondary battery according to claim 1, wherein the positive electrode mixture contains 0.1% by mass or more and 5.0% by mass or less of the lithium phosphate relative to the total mass of the positive electrode active material.

4. The nonaqueous electrolyte secondary battery according to claim 1, wherein the nonaqueous electrolyte contains 0.1% by mass or more and 5.0% by mass or less of the organic additive.

5. The nonaqueous electrolyte secondary battery according to claim 4, wherein the nonaqueous electrolyte contains cyclohexylbenzene as the cycloalkyl benzene compound.

6. The nonaqueous electrolyte secondary battery according to claim 4, wherein the nonaqueous electrolyte contains tert-amylbenzene as the compound having quaternary carbon adjacent to a benzene ring.

7. The nonaqueous electrolyte secondary battery according to claim 1, wherein the nonaqueous electrolyte further contains 1.5 to 5% by mass of vinylene carbonate.
